(19) United States
(12) Patent Application Publication
(10) Pub. No.: US 2023/0277938 A1
(43) Pub. Date: Sep. 7, 2023

(54) METHOD AND DEVICE FOR PROVIDING GAME SERVICE

(71) Applicant: NEXON KOREA CORPORATION, Seongnam-si (KR)

(72) Inventor: Ki On KIM, Seongnam-si (KR)

(21) Appl. No.: 18/178,391

(22) Filed: Mar. 3, 2023

(30) Foreign Application Priority Data
Mar. 4, 2022 (KR) 10-2022-0028217

(51) Int. Cl. A63F 13/58; G06Q 20/36; G06Q 20/38; A63F 13/792

(52) U.S. Cl. CPC A63F 13/58; G06Q 20/36; G06Q 20/381; A63F 13/792

(57) ABSTRACT

Provided are a method and device for providing a game, and the method includes linking an electronic wallet for trading a cryptocurrency over a blockchain network, to an account of a user using the game service, obtaining information of a cryptocurrency owned by the electronic wallet, and based on the obtained information of the cryptocurrency, providing a certain in-game effect to the user.

### CROSS-REFERENCE TO RELATED APPLICATION

This application is based on and claims priority under 35 U.S.C. § 119 to Korean Patent Application No. 10-2022-0028217, filed on Mar. 4, 2022, in the Korean Intellectual Property Office, the disclosure of which is incorporated by reference herein in its entirety.

### BACKGROUND

### 1. Field

The disclosure relates to a method and device for providing a game service. More particularly, the disclosure relates to a method and device for providing an in-game effect, based on a cryptocurrency owned by a user using a game service.

### 2. Description of the Related Art

Recently, cryptocurrencies using various types of cryptographic systems are emerging one after another and attracting attention. Cryptocurrencies have no physical form, are used only in a virtual environment on a network, and are issued and traded by peer-to-peer (P2P) distributed processing using blockchain technology. That is, because cryptocurrencies have no issuer unlike typical currencies, anyone may mine a cryptocurrency by performing decryption, and with no central processing unit for storing transaction details, transaction details are stored in all nodes constituting a blockchain.

As interest in cryptocurrency increases, a method of using a cryptocurrency in a game service to increase the interest of a user is required.

### SUMMARY

Provided are a method and device for providing an in-game effect, based on information of a cryptocurrency owned by a user using a game service.

Additional aspects will be set forth in part in the description which follows and, in part, will be apparent from the description, or may be learned by practice of the presented embodiments of the disclosure.

According to an aspect of the disclosure, a method of providing a game service includes linking an electronic wallet for trading a cryptocurrency over a blockchain network, to an account of a user using the game service, obtaining information of a cryptocurrency owned by the electronic wallet, and based on the obtained information of the cryptocurrency, providing a certain in-game effect to the user.

According to an embodiment, the linking of the electronic wallet may include obtaining electronic wallet information including at least one of identification information of the electronic wallet and authentication information of the electronic wallet, verifying validity of the obtained electronic wallet information, and based on the obtained electronic wallet information being valid, registering the obtained electronic wallet information in the account of the user.

According to an embodiment, the obtaining of the information of the cryptocurrency may include obtaining the quantity of the cryptocurrency owned by the electronic wallet.

According to an embodiment, the obtaining of the information of the cryptocurrency may further include obtaining the quantity of a cryptocurrency of a certain type owned by the electronic wallet.

According to an embodiment, the obtaining of the quantity of the cryptocurrency may include obtaining a quantity of a first cryptocurrency by converting a quantity of a second cryptocurrency owned by the electronic wallet into the quantity of the first cryptocurrency, based on an exchange rate between the first cryptocurrency and the second cryptocurrency.

According to an embodiment, the in-game effect may be provided in proportion to the quantity of the cryptocurrency.

According to an embodiment, based on the quantity of the cryptocurrency being greater than a preset threshold value, the in-game effect may be provided in a fixed amount regardless of the quantity of the cryptocurrency.

According to an embodiment, the providing of the in-game effect may include, based on the obtained information of the cryptocurrency, improving an ability of a character of the user in a game.

According to an embodiment, the method of providing a game service may further include providing an interface for displaying, in a game screen, the obtained information of the cryptocurrency and the provided in-game effect.

According to an embodiment, the electronic wallet may be for trading a cryptocurrency different from a virtual currency used in the game service.

According to another aspect of the disclosure, a device for providing a game includes a memory storing instructions, and at least one processor functionally coupled to the memory. The at least one processor may be configured to execute the instructions to link an electronic wallet for trading a cryptocurrency over a blockchain network, to an account of a user using a game service, obtain information of a cryptocurrency owned by the electronic wallet, and based on the obtained information of the cryptocurrency, provide a certain in-game effect to the user.

According to an embodiment, the at least one processor may be further configured to execute the instructions to obtain electronic wallet information including at least one of identification information of the electronic wallet and authentication information of the electronic wallet, verify the validity of the obtained electronic wallet information, and based on the obtained electronic wallet information being valid, register the obtained electronic wallet information in the account of the user.

According to an embodiment, the at least one processor may be further configured to execute the instructions to obtain the quantity of the cryptocurrency owned by the electronic wallet.

According to an embodiment, the at least one processor may be further configured to execute the instructions to obtain the quantity of a cryptocurrency of a certain type owned by the electronic wallet.

According to an embodiment, the at least one processor may be further configured to execute the instructions to obtain a quantity of a first cryptocurrency by converting a quantity of a second cryptocurrency owned by the electronic wallet into the quantity of the first cryptocurrency, based on an exchange rate between the first cryptocurrency and the second cryptocurrency.

According to an embodiment, the at least one processor may be further configured to execute the instructions to provide the in-game effect in proportion to the quantity of the cryptocurrency.

According to an embodiment, the at least one processor may be further configured to execute the instructions to, based on the quantity of the cryptocurrency being greater than a preset threshold value, provide the in-game effect in a fixed amount regardless of the quantity of the cryptocurrency.

According to an embodiment, the at least one processor may be further configured to execute the instructions to, based on the obtained information of the cryptocurrency, improve an ability of the user in the game.

According to an embodiment, the at least one processor may be further configured to execute the instructions to provide an interface for displaying, in a game screen, the obtained information of the cryptocurrency and the provided in-game effect.

According to an embodiment, the electronic wallet may be for trading a cryptocurrency different from a virtual currency used in the game service.

According to another aspect of the disclosure, a server includes a memory storing instructions, and at least one processor functionally coupled to the memory. The at least one processor may be configured to execute the instructions to link an electronic wallet for trading a cryptocurrency over a blockchain network, to an account of a user using a game service, obtain information of a cryptocurrency owned by the electronic wallet, and based on the obtained information of the cryptocurrency, provide a certain in-game effect to the user.

According to another aspect of the disclosure, a computer program is recorded on a medium for executing a method of providing a game service in combination with hardware, and the method includes linking an electronic wallet for trading a cryptocurrency over a blockchain network, to an account of a user using the game service, obtaining information of a cryptocurrency owned by the electronic wallet, and based on the obtained information of the cryptocurrency, providing a certain in-game effect to the user.

According to another aspect of the disclosure, a computer-readable recording medium has recorded thereon a program for executing, on a computer, a method of providing a game service, and the method includes linking an electronic wallet for trading a cryptocurrency over a blockchain network, to an account of a user using the game service, obtaining information of a cryptocurrency owned by the electronic wallet, and based on the obtained information of the cryptocurrency, providing a certain in-game effect to the user.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a game providing system including a server and a user terminal, according to various embodiments;

FIG. 2 is a diagram for describing a game providing method according to various embodiments;

FIG. 3 is a block diagram of a game providing system according to various embodiments;

FIG. 4 is a flowchart of a game providing method according to various embodiments;

FIG. 5 is a flowchart of a method of linking an electronic wallet to an account of a user using a game service, according to various embodiments;

FIG. 6 is a diagram for describing a method of providing an in-game effect based on a cryptocurrency according to an embodiment;

FIG. 7 is a diagram for describing a method of providing an in-game effect based on a cryptocurrency according to an embodiment;

FIG. 8 is a diagram for describing an interface for displaying an in-game effect according to various embodiments;

FIG. 9 is a diagram for describing a detailed configuration of a game providing device according to various embodiments;

FIG. 10 is a diagram for describing a detailed configuration of a server according to various embodiments; and

FIG. 11 is a diagram for describing a detailed configuration of a user terminal according to various embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments according to the disclosure will be described in detail with reference to the accompanying drawings. In addition, a method of configuring and using an electronic device according to an embodiment will be described in detail with reference to the accompanying drawings. Like reference numerals in the drawings indicate parts or components that perform substantially the same functions.

Terms such as “first” or “second” may be used to describe various elements, but the elements are not limited by the terms. These terms are only used to distinguish one element from another element. For example, a first element may be referred to as a second element, and a second element may be referred to as a first element in a similar manner, without departing from the scope of the disclosure. The term “and/or” includes any and all combinations of one or more of the associated listed items.

Terms used herein are for describing embodiments and are not intended to limit the scope of the disclosure. A singular expression may include a plural expression unless they are definitely different in a context. As used herein, terms such as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

Throughout the specification, when a part is referred to as being “connected to” another part, it may be “directly connected to” the other part or be “electrically connected to” the other part through an intervening element. In addition, when an element is referred to as “including” a component, the element may additionally include other components rather than excluding other components as long as there is no particular opposing recitation. In addition, as used herein, the terms such as “ . . . er (or)”, “ . . . unit”, “ . . . module”, etc., denote a unit that performs at least one function or operation, which may be implemented as hardware or software or a combination thereof.

In the disclosure, a character may refer to a certain object that may be controlled by a user in a game.

In the disclosure, an account of a user of a game service may refer to an account of the user including at least one character. In the game, the user may create a plurality of characters, and the plurality of characters may be subordinate to one account of the user. The disclosure is not limited to the above example, and the game service may be provided through one account of the user.

In the disclosure, a game providing device may be a game server, a user terminal, a game system including a game server and a user terminal, or an independent device.

In the disclosure, that a server controls a user terminal may mean that the server provides, through communication with the user terminal, output for the user terminal (all output devices in the user terminal, such as screen display, sound output, vibration output, lamp emission, etc.) and data for the user terminal to perform a certain operation. The user terminal may also control output from the user terminal by using pre-stored data, and the disclosure is not limited to the above example.

In the disclosure, that information or data is transmitted or received to or from a user (or an account of the user) may mean that the information or data is transmitted or received to or from a device (or a user terminal) corresponding to or linked to the user (or the account of the user).

In the disclosure, an account of a user corresponding to a user terminal may include an account with which the user has logged in to or accessed a service through the user terminal, and an account of the user, the information of which is stored in the user terminal. In addition, a user terminal of an account of a user may refer to a user terminal to which the user has logged in with the account, in which information of the account of the user is stored, or that the user has accessed with the account.

In the disclosure, the terms “user”, “player”, “account of user”, and “gamer” may be used in the same meaning. It should be understood that, in the disclosure, a user terminal may refer to a user, a player, an account of a user, a gamer, or a device used thereby, depending on the context. It should be understood that, in the disclosure, a user, a player, an account of a user, or a gamer may refer to an avatar or a character controlled thereby, or a device used thereby, depending on the context.

In the disclosure, a blockchain network may be a network using blockchain technology. The blockchain technology may refer to data forgery prevention technology based on distributed computing technology. In detail, the blockchain technology may refer to a peer-to-peer (P2P)-based technology of storing data to be managed, in a distributed data storage environment called ‘block’ in which pieces of low-volume data are connected to each other in the form of a chain, thereby preventing anyone from arbitrarily (i.e., without authority) modifying the stored data and allowing anyone to view results of modification.

All pieces of data that have been propagated to users before the block is discovered are recorded in the block, and are transmitted equally to all of the users in a P2P manner. Thus, the user cannot arbitrarily modify or omit the data. The block has a link to the date of discovery and the previous block, and a set of such blocks may be referred to as a blockchain. That is, the blockchain technology is to make numerous records into a bundle.

A block is a unit for storing data and is divided into a body and a header. The body may contain transaction details, and the header may contain cryptographic code such as a Merkle hash (a Merkle root) or a nonce (an arbitrary number related to encryption). For example, a block may be created in a cycle of about 10 minutes.

A block may be created by collecting transaction records and verifying reliability, and the created block may be connected to a previous block to form a blockchain. As another example, in the specification, arbitrary data propagated over the blockchain may be accumulated in a certain amount to form block data, and the formed block data may be verified by nodes in the blockchain and then connected to previous block data.

Transaction records of a blockchain are not stored in and managed by a centralized server, but individual servers participating in transactions may gather to maintain and manage a network. Such individual servers, i.e., participants, are called nodes. In the disclosure, a game providing device, a user terminal, or a server may correspond to one of nodes.

Because there is no central manager, the role of nodes distributing a block is important in a blockchain network, and a new block is created only when there is agreement from more than half of the participating nodes. The nodes store the blockchain in their computers, and even in a case in which some nodes are hacked and the content therein is altered, the data remains in the majority of the nodes, and thus, the data may be continuously preserved.

In addition, in the disclosure, arbitrary pieces of data propagated to a blockchain are stored in blockchain-participating nodes, and it is possible to verify whether the data is forged or altered by periodically/non-periodically comparing the data of the participating nodes with each other.

In this disclosure, a cryptocurrency may refer to a digital currency designed to function as a medium of exchange on a network using blockchain technology. A cryptocurrency may be stored in a distributed ledger on a blockchain, and a cryptographic method may be used to ensure the safety of transactions, control the creation of additional units, and authenticate the transfer of assets.

In the disclosure, an electronic wallet may refer to software, a recording medium, or a service for storing, transmitting, receiving, and trading a cryptocurrency in association with a blockchain network. The electronic wallet may include a unique address, an encryption key for managing the cryptocurrency, and the like. It should be understood that, in the disclosure, a cryptocurrency owned by an electronic wallet may refer to a cryptocurrency owned by a user of the electronic wallet, depending on the context.

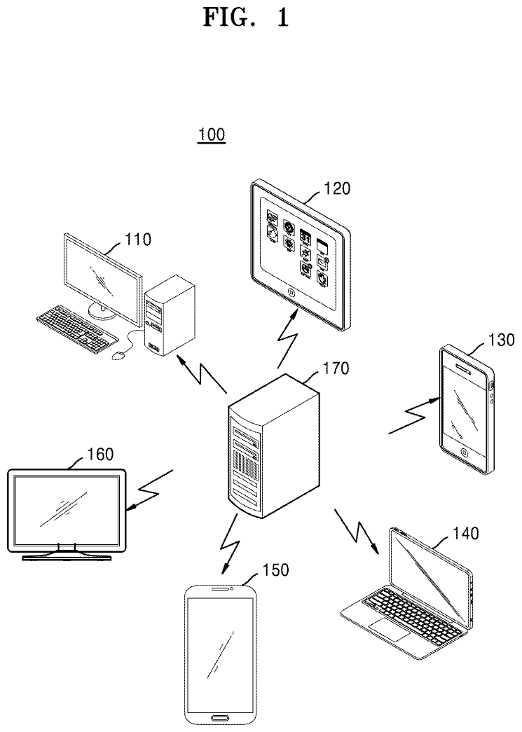

FIG. 1 illustrates a game providing system including a server and a user terminal, according to various embodiments.

A game providing system 100 of the disclosure may include a server 170 and one or more user terminals 110 to 160. The server 170 may provide various online activities through a network. The server 170 may simultaneously provide online activities to the one or more user terminals 110 to 160.

According to an embodiment, the server 170 may include a single server, a collection of servers, a cloud server, and the like, but is not limited to the above examples. The server 170 provides various online activities and may include a database storing data for the online activities. Also, the server 170 may include a payment server for generating and processing a payment event. As described above, the server 170 may be a game providing device.

According to an embodiment, the network may refer to a connection established (or created) by using any communication scheme, and may refer to a communication network established through any communication scheme to enable transmission and reception of data between terminals or between a terminal and a server.

‘Any communication scheme’ may encompass all communication schemes such as communication through a certain communication standard, a certain frequency band, a certain protocol, or a certain channel. For example, it may include Bluetooth, Bluetooth Low Energy (BLE), Wi-Fi, Zigbee, Third Generation (3G), Long-Term Evolution (LTE), communication schemes using ultrasonic waves, and the like, and may include short-range communication, long-range communication, wireless communication, and wired communication. The disclosure is not limited to the above examples.

According to an embodiment, a short-range communication scheme may refer to a communication scheme in which communication is available only when a device (a terminal or a server) performing the communication is within a certain range, and may include, for example, Bluetooth, near-field communication (NFC), and the like. A long-range communication scheme may refer to a communication scheme in which a device performing communication may perform the communication regardless of distance. For example, the long-range communication scheme may refer to a scheme in which two devices performing communication through a repeater such as an access point (AP) may communicate with each other even when they are far away from each other more than a certain distance, and may include a cellular network (e.g., 3G or LTE), such as Short Message Service (SMS) or phone calls. The disclosure is not limited to the above examples. Being provided with online activities by using a network may mean that communication between a server and a terminal may be performed through any communication scheme.

Throughout the specification, the one or more user terminals 110 to 160 may include a personal computer 110, a tablet 120, a cellular phone 130, a notebook computer 140, a smart phone 150, and a television (TV) 160, as well as a personal digital assistant (PDA), a portable multimedia player (PMP), a navigation device, an MP3 player, a digital camera, a refrigerator, a washing machine, a vacuum cleaner, and the like, but are not limited to the above examples. As described above, the one or more user terminals 110 to 160 may be game providing devices.

According to an embodiment, the online activities may include an online game, a portal service, and a social network service (SNS), but are not limited to the above examples. In addition, the online games may include various genres such as sports, massive multiplayer online role-playing game (MMORPG), Aeon of Strife (AOS), first-person shooter (FPS), trading card game (TCG), collectible card game (CCG), or the like. In addition, the online game may be a game of competition between users, or may be a game of competition between a user and a computer (e.g., artificial intelligence). Also, the online game may be a game of construction or decoration rather than competition. The online game is not limited to the above examples, and there is no limitation to the form of the online game.

The user terminals 110 to 160 and the server 170 of the disclosure may communicate with a blockchain network (not shown). The blockchain network may be entirely hardware, or partly hardware and partly software, and may consist of one or more servers or computers, terminals, etc.

According to various embodiments, the game providing system 100 may link an electronic wallet for trading a cryptocurrency over a blockchain network, to an account of a user using a game service. The game providing system 100 may obtain information of a cryptocurrency owned by the electronic wallet. The game providing system 100 may provide a certain in-game effect to the user, based on the obtained information of the cryptocurrency. This will be described in more detail below.

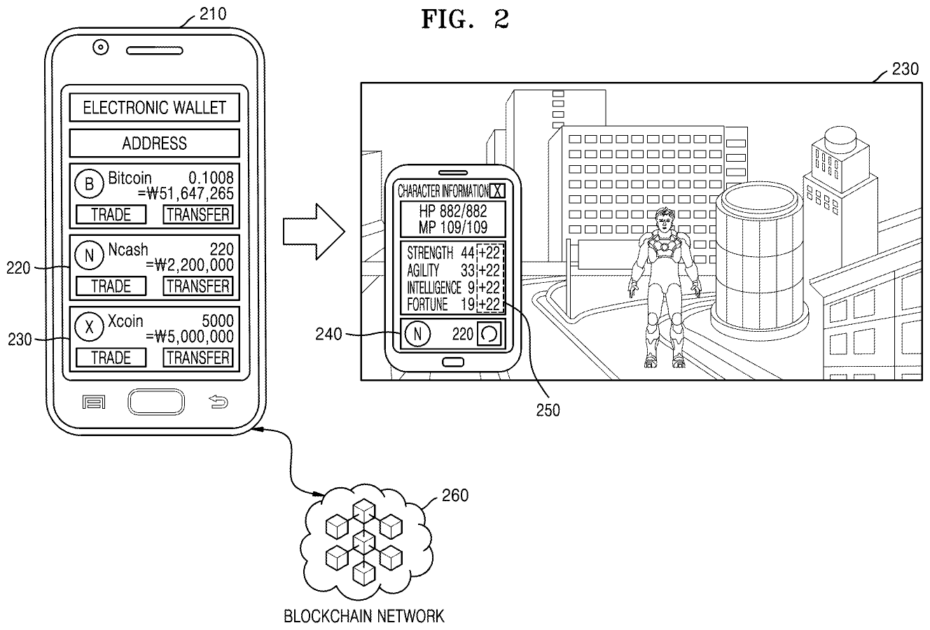

FIG. 2 is a diagram for describing a game providing method according to various embodiments.

Referring to FIG. 2, an electronic wallet 210 may communicate with a blockchain network 260 to manage a cryptocurrency owned by a user. In various embodiments, the electronic wallet 210 may be a software wallet, such as a client wallet installed on a user terminal or a web wallet running on a server and accessible by using a web browser. In some embodiments, the electronic wallet 210 may be a hardware wallet that is a physical recording medium that may be used by connecting to another device. An example in which the electronic wallet 210 is installed and executed in a user terminal is described in the disclosure, but it should be understood that various embodiments may be applied to any type of electronic wallet 210. In addition, it should be understood that a user terminal or an electronic device in which the electronic wallet 210 is installed or executed may be a device separate from the game providing device, the user terminal 110, or the game server 170 of the disclosure.

In an embodiment, the electronic wallet 210 may be created by a cryptocurrency exchange or a cryptocurrency management service. For example, the user may create a user account in the cryptocurrency exchange or the cryptocurrency management service to receive the electronic wallet 210 corresponding to the user account of the cryptocurrency exchange or the cryptocurrency management service.

In various embodiments, the electronic wallet 210 may manage at least one type of cryptocurrency. In an embodiment, the electronic wallet 210 may manage a plurality of types of cryptocurrency. For example, the electronic wallet 210 may manage a first cryptocurrency 220 and a second cryptocurrency 230. Different cryptocurrencies with different values may be traded over the blockchain network 260.

The game providing device may link the electronic wallet 210 for trading a cryptocurrency over the blockchain network 260, to the account of the user using the game service. In other words, the game providing device may register information of the electronic wallet 210 in the account of the user using the game service.

In various embodiments, the provider of the game service may be different from the provider of the cryptocurrency exchange or the cryptocurrency management service that has created the electronic wallet 210. That is, the game providing device may link any electronic wallet 210 not associated with the game service, to the account of the user using the game service. In various embodiments, the cryptocurrency managed by the electronic wallet 210 may be different from a virtual currency used in the game service.

Based on the electronic wallet 210 being linked to the account of the user of the game service, the game providing device may obtain information 240 about a cryptocurrency owned by the electronic wallet 210. In various embodiments, the game providing device may obtain the quantity of a cryptocurrency owned by the electronic wallet 210.

In various embodiments, the game providing device may obtain the quantity of a cryptocurrency of a certain type owned by the electronic wallet 210. In an embodiment, the game providing device may obtain a certain type of cryptocurrency that provides an in-game effect, and obtain the quantity of the cryptocurrency of the obtained type. For example, the game providing device may obtain the quantity of the first cryptocurrency 220 owned by the electronic wallet 210.

The game providing device may provide a certain in-game effect 250 to the user, based on the obtained information 240 about the cryptocurrency. In an embodiment, the in-game effect 250 may be an effect that may be beneficial to the user in playing the game. For example, the in-game effect 250 may improve the ability of a character of the user, decrease the ability of a character competing with the character of the user, apply a discount to the price of an item to purchase in the game, or increase the probability of obtaining in-game goods. The disclosure is not limited to the above examples.

In an embodiment, the game providing device may display an interface for displaying, in a game screen, the information 240 about the cryptocurrency owned by the electronic wallet 210 linked to the account of the user. In an embodiment, the game providing device may display an interface for displaying, in the game screen, the in-game effect 250 provided based on the information 240 about the cryptocurrency.

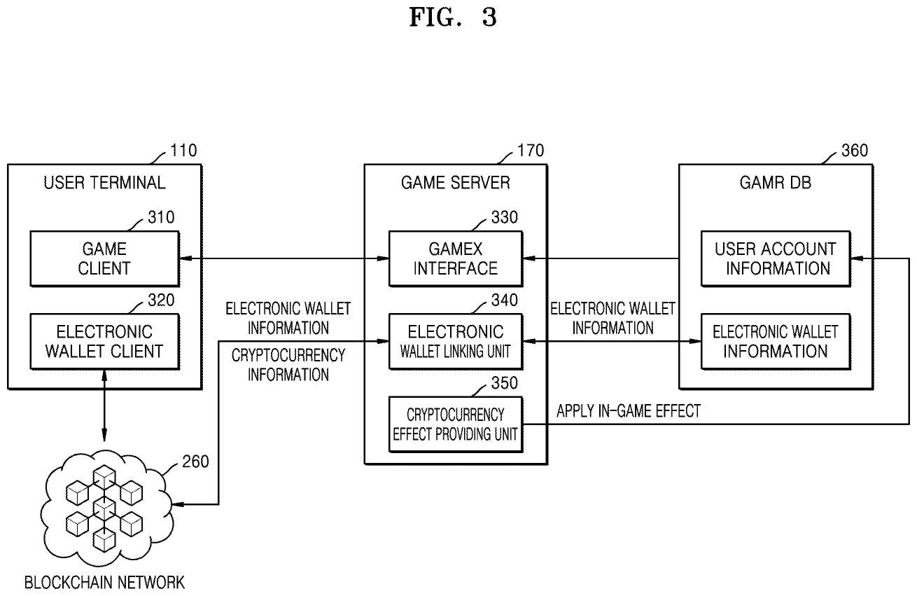

FIG. 3 is a block diagram of a game providing system according to various embodiments.

Referring to FIG. 3, the game providing system may include the user terminal 110, the game server 170, a game database (DB) 360, and the blockchain network 260. The user terminal 110 is an electronic device capable of executing a game, and may correspond to the user terminals 110 to 160 of FIG. 1. The game server 170 is a server device for providing a game service, and may correspond to the server 170 of FIG. 1. The user terminal 110 and the game server 170 may communicate with the blockchain network 260.

However, not all of the components illustrated in FIG. 3 are essential components of the game providing system. The game providing system may be implemented by more or fewer components than the components illustrated in FIG. 3. For example, the user terminal 110 may perform functions of the game server 170 and the game DB 360 according to various embodiments.

In various embodiments, the user terminal 110 may include a game client 310 and an electronic wallet client 320. Although FIG. 3 illustrates an example in which one user terminal 110 includes both the game client 310 and the electronic wallet client 320, the game client 310 and the electronic wallet client 320 may be included in different user terminals.

The game client 310 may communicate with a game interface 330 of the game server 170 to provide the game service to the user terminal. In an embodiment, the game client 310 may receive an input of the user performing game content and transmit the input to the game server 170. In an embodiment, the game client 310 may receive a result of the user input processed by the game server 170, and display the result through a game screen.

In an embodiment, the game client 310 may display an interface for displaying, in the game screen, information of a cryptocurrency owned by an electronic wallet linked to an account of the user. In an embodiment, the game client 310 may display an interface for displaying, in the game screen, an in-game effect provided based on the information of the cryptocurrency.

The electronic wallet client 320 may communicate with the blockchain network 260 to manage a cryptocurrency owned by the user. In an embodiment, the electronic wallet client 320 may communicate with the blockchain network 260 to store and update information of a cryptocurrency owned by the user. In an embodiment, the electronic wallet client 320 may perform a trade or a transfer of a cryptocurrency by executing a smart contract.

In various embodiments, the electronic wallet client 320 may display an electronic wallet interface for displaying account information of the user and information of the cryptocurrency owned by the user. In an embodiment, the electronic wallet interface may display the address of the electronic wallet and the type, quantity, exchange rate, and exchange value of the owned cryptocurrency. In an embodiment, the electronic wallet interface may include an interface for trading or transferring a cryptocurrency.

In various embodiments, the game server 170 may include the game interface 330, an electronic wallet linking unit 340, and a cryptocurrency effect providing unit 350.

The game interface 330 may communicate with the game client 310 of the user terminal 110 to provide the game service to the user. In an embodiment, the game interface 330 may obtain, from the game DB 360, account information of the user including information about an in-game effect provided based on cryptocurrency information, and provide the game service to the user, based on the obtained account information of the user.

The electronic wallet linking unit 340 may link an electronic wallet for trading a cryptocurrency over the blockchain network 260, to the account of the user using the game service. In an embodiment, the electronic wallet linking unit 340 may obtain, from the user terminal 110, information of an electronic wallet to be linked to the account of the user, and store, in the game DB 360, the obtained information of the electronic wallet. In an embodiment, the stored information of the electronic wallet may be stored in association with the account information of the user stored in the game DB 360.

In various embodiments, the electronic wallet linking unit 340 may obtain the information of the electronic wallet including at least one of identification information of the electronic wallet and authentication information of the electronic wallet. In various embodiments, the electronic wallet linking unit 340 may verify the validity of the obtained information of the electronic wallet. In various embodiments, based on the obtained information of the electronic wallet being valid, the electronic wallet linking unit 340 may register the obtained information of the electronic wallet, in the account of the user.

In an embodiment, based on receiving, from the user terminal 110, a request of the user to link the electronic wallet to the account of the user, the electronic wallet linking unit 340 may link the electronic wallet to the account of the user.

The electronic wallet linking unit 340 may obtain information of a cryptocurrency owned by the electronic wallet linked to the account of the user of the game service. In an embodiment, based on the information of the electronic wallet stored in the game DB 360, the electronic wallet linking unit 340 may request, from a block (a node) constituting the blockchain network 260, the information of the cryptocurrency owned by the electronic wallet. In an embodiment, the electronic wallet linking unit 340 may store the obtained information of the cryptocurrency, in the game DB 360.

In various embodiments, the electronic wallet linking unit 340 may obtain the quantity of the cryptocurrency owned by the electronic wallet. In various embodiments, the electronic wallet linking unit 340 may obtain the quantity of a cryptocurrency of a certain type owned by the electronic wallet.

The cryptocurrency effect providing unit 350 may provide a certain in-game effect to the user, based on the information of the cryptocurrency obtained by the electronic wallet linking unit 340. In an embodiment, the cryptocurrency effect providing unit 350 may store, in the game DB 360, information about an in-game effect provided to the user.

In an embodiment, as the quantity of the cryptocurrency owned by the electronic wallet linked to the account of the user increases, the cryptocurrency effect providing unit 350 may provide a better in-game effect. For example, the cryptocurrency effect providing unit 350 may provide a certain in-game effect in proportion to the quantity of the cryptocurrency.

The game DB 360 may store and manage data for the game server 170 to provide a game. FIG. 3 illustrates that the game DB 360 and the game server 170 are separate from each other, but according to another embodiment, the game DB 360 may be included in the game server 170.

The game DB 360 may store a record of in-game activities that has been done by the user. For example, the game DB 360 may store information or data regarding a record of the user logging in to a game, a record of the user logging out of the game, a record of changing information of the user, a record of in-game actions performed by a character of the user, and the like.

In various embodiments, the game DB 360 may store information of an electronic wallet in association with the account information of the user. In an embodiment, the information of the electronic wallet may include at least one of identification information and authentication information of the electronic wallet. In various embodiments, the game DB 360 may store information of a cryptocurrency owned by the electronic wallet. In various embodiments, the game DB 360 may store information about an in-game effect provided to the account of the user, based on the information of the cryptocurrency.

The user terminal 110 and the game server 170 may communicate with the blockchain network 260. The blockchain network 260 may be a network using blockchain technology. The blockchain network 260 may be entirely hardware, or partly hardware and partly software, and may consist of one or more servers or computers, terminals, etc.

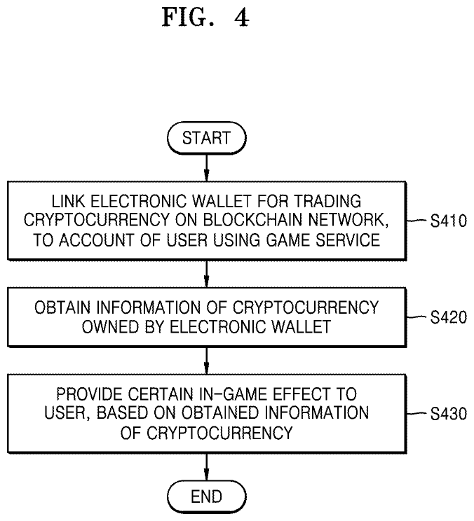

FIG. 4 is a flowchart of a game providing method according to various embodiments.

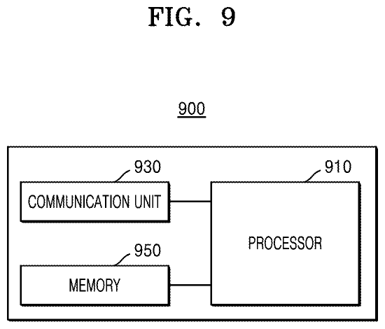

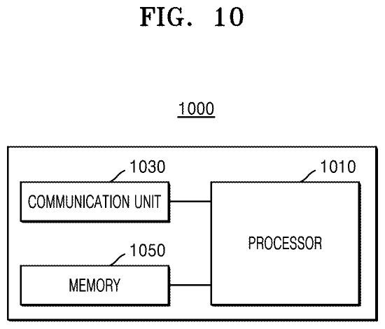

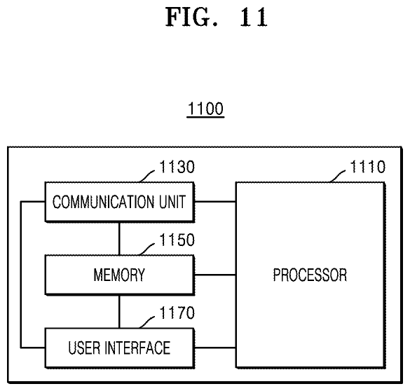

The operations illustrated in FIG. 4 may be performed by the user terminals 110 to 160 and the server 170 illustrated in FIG. 1, the user terminal 110 and the server 170 illustrated in FIG. 3, a game providing device 900 illustrated in FIG. 9 or a processor 910 of the game providing device 900, a server 1000 illustrated in FIG. 10 or a processor 1010 of the server 1000, or a user terminal 1100 illustrated in FIG. 11 or a processor 1110 of the user terminal 1100.

Referring to FIG. 4, in operation S410, a game providing device may link an electronic wallet for trading a cryptocurrency over a blockchain network, to an account of a user using a game service. In an embodiment, the game providing device may obtain information of the electronic wallet to be linked to the account of the user, and store the obtained information of the electronic wallet.

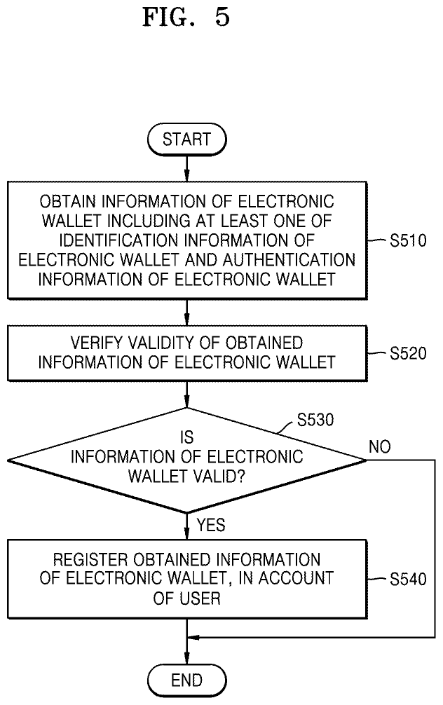

In various embodiments, the game providing device may obtain the information of the electronic wallet including at least one of identification information of the electronic wallet and authentication information of the electronic wallet. In various embodiments, the game providing device may verify the validity of the obtained information of the electronic wallet. In various embodiments, based on the obtained information of the electronic wallet being valid, the game providing device may register the obtained information of the electronic wallet, in the account of the user. This will be described in more detail with reference to FIG. 5.

In various embodiments, based on receiving a request of the user to link the electronic wallet to the account of the user, the game providing device may link the electronic wallet to the account of the user.

In operation S420, the game providing device may obtain information of a cryptocurrency owned by the electronic wallet. In an embodiment, based on the information of the electronic wallet linked to the account of the user, the game providing device may search blocks (nodes) constituting the blockchain network for the information of the cryptocurrency owned by the electronic wallet. In an embodiment, the game providing device may store the obtained information of the cryptocurrency.

In various embodiments, the game providing device may obtain the quantity of the cryptocurrency owned by the electronic wallet. In various embodiments, the game providing device may obtain the quantity of a cryptocurrency of a certain type owned by the electronic wallet.

In operation S430, the game providing device may provide a certain in-game effect to the user, based on the obtained information of the cryptocurrency.

In an embodiment, the in-game effect may be an effect that may be beneficial to the user in playing a game. For example, the in-game effect may improve the ability of a character of the user, decrease the ability of a character hostile to the character of the user, apply a discount to the price of an item to purchase in the game, or increase the probability of obtaining in-game goods. The disclosure is not limited to the above examples.

In an embodiment, as the quantity of the cryptocurrency owned by the electronic wallet linked to the account of the user increases, the game providing device may provide a better in-game effect. For example, the in-game effect may be provided in proportion to the quantity of the cryptocurrency. That is, a value of the in-game effect provided per unit of the cryptocurrency owned by the electronic wallet linked to the account of the user may be fixed.

FIG. 5 is a flowchart of a method of linking an electronic wallet to an account of a user using a game service, according to various embodiments.

The operations illustrated in FIG. 5 may be performed by the user terminals 110 to 160 and the server 170 illustrated in FIG. 1, the user terminal 110 and the server 170 illustrated in FIG. 3, the game providing device 900 illustrated in FIG. 9 or the processor 910 of the game providing device 900, the server 1000 illustrated in FIG. 10 or the processor 1010 of the server 1000, or the user terminal 1100 illustrated in FIG. 11 or the processor 1110 of the user terminal 1100. Operations S510 to S540 of FIG. 5 may correspond to operation S410 of FIG. 4.

In operation S510, a game providing device may obtain information of an electronic wallet including at least one of identification information of the electronic wallet and authentication information of the electronic wallet. In an embodiment, the identification information of the electronic wallet may be unique information for identifying the electronic wallet. For example, the identification information of the electronic wallet may be the address of the electronic wallet, or an identifier (ID), code, or a public key corresponding to the address. In an embodiment, the authentication information of the electronic wallet may be information necessary to obtain transaction authority of the electronic wallet. For example, the authentication information of the electronic wallet may be a password, a certificate, a private key, or the like of the electronic wallet.

In various embodiments, the game providing device may obtain the information of the electronic wallet, based on an input of the user. In an embodiment, based on receiving a request of the user to link the electronic wallet to the account of the user, the game providing device may provide a user interface for receiving an input of the information of the electronic wallet. In an embodiment, the game providing device may obtain, through the user interface, a user input including at least one of the identification information of the electronic wallet and the authentication information of the electronic wallet.

In operation S520, the game providing device may verify the validity of the obtained information of the electronic wallet. In an embodiment, the game providing device may search blocks (nodes) constituting a blockchain network for information of the electronic wallet, by using the obtained information of the electronic wallet. In a case in which the corresponding electronic wallet does not exist on the blockchain network or obtaining of the information of the electronic wallet fails, the game providing device may determine that the obtained information of the electronic wallet is invalid. In an embodiment, the game providing device may identify whether the obtained information of the electronic wallet has already been registered in another user account. In a case in which the electronic wallet is identified as having already been registered, the game providing device may determine that the obtained information of the electronic wallet is invalid.

In various embodiments, in order to verify whether the owner of the electronic wallet is identical to the user of the game service, the game providing device may request a separate authentication procedure. In an embodiment, the game providing device may request the owner of the electronic wallet to authenticate the user account of the game service to be linked. In another embodiment, the game providing device may request the user of the game service to authenticate the ownership of the electronic wallet. In a case in which the authentication fails, the game providing device may determine that the obtained information of the electronic wallet is invalid. Because the address and transaction information of an electronic wallet using blockchain technology is available to everyone, it is possible to prevent abusing to illegally use other people's electronic wallets, by performing a separate authentication procedure.

In operation S530, the game providing device may determine whether the obtained information of the electronic wallet is valid. In a case in which the obtained information of the electronic wallet is valid, the game providing device may perform operation S540. In a case in which the obtained information of the electronic wallet is invalid, the game providing device may terminate the process of linking the electronic wallet to the account of the user.

In operation S540, the game providing device may register the obtained information of the electronic wallet, in the account of the user. In an embodiment, the game providing device may store the obtained information of the electronic wallet, in association with user account information stored in a game DB. The stored information of the electronic wallet may include at least one of identification information and authentication information of the electronic wallet.

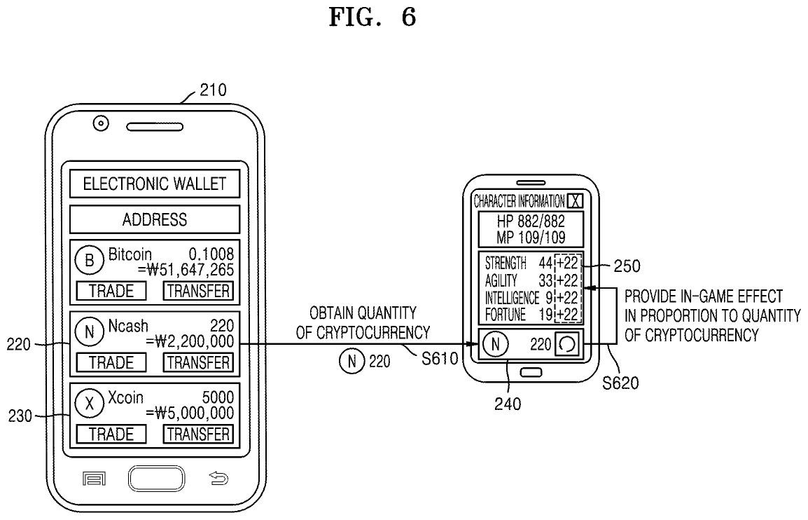

FIG. 6 is a diagram for describing a method of providing an in-game effect based on a cryptocurrency according to an embodiment.

Referring to FIG. 6, in operation S610, a game providing device may obtain the quantity of a cryptocurrency owned by an electronic wallet. In an embodiment, the game providing device may obtain a certain type of cryptocurrency that provides an in-game effect, and obtain the quantity of the cryptocurrency of the obtained type. For example, in a case in which the first cryptocurrency 220 is set as a cryptocurrency providing the in-game effect, the game providing device may obtain the quantity of the first cryptocurrency 220 owned by the electronic wallet.

In an embodiment, the game providing device may store the obtained quantity of the first cryptocurrency 220. In an embodiment, the game providing device may display the obtained quantity of the first cryptocurrency 220, as the information 240 about the cryptocurrency in a game.

In operation S620, the game providing device may provide the in-game effect 250 in proportion to the quantity of the cryptocurrency. In an embodiment, the in-game effect provided per unit of the cryptocurrency may be preset.

For example, the game providing device may provide an effect of increasing a certain ability of a character of a user by a fixed value (e.g., 0.1) per unit of a first cryptocurrency owned by an electronic wallet linked to an account of the user. For example, the game providing device may provide an effect of decreasing a certain ability of a character competing with the character of the user by a fixed value per unit of the first cryptocurrency owned by the electronic wallet linked to the account of the user. For example, the game providing device may provide an effect of discounting the price of an item to purchase in the game by a fixed percentage per unit of the first cryptocurrency owned by the electronic wallet linked to the account of the user. For example, the game providing device may provide an effect of increasing the user's probability of obtaining in-game goods by a fixed value per unit of the first cryptocurrency owned by the electronic wallet linked to the account of the user. The disclosure is not limited to the above examples.

In an embodiment, in a case in which the quantity of the cryptocurrency is greater than a preset threshold value, the game providing device may provide the fixed in-game effect 250 regardless of the quantity of the cryptocurrency. For example, in a case in which the threshold value for the quantity of the cryptocurrency that provides the in-game effect is set to 1000, and the quantity of the cryptocurrency owned by the electronic wallet is greater than 1000, the game providing device may provide only the in-game effect corresponding to 1000 units of the cryptocurrency. The threshold value may be preset to a value that does not affect the balance of the game service.

In an embodiment, the game providing device may display an interface for displaying, in a game screen, the in-game effect 250 provided based on the information 240 about the cryptocurrency.

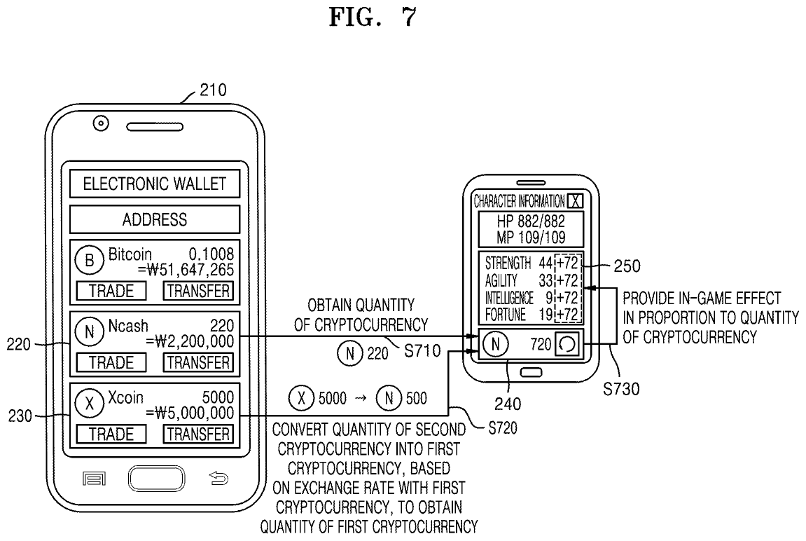

FIG. 7 is a diagram for describing a method of providing an in-game effect based on a cryptocurrency according to an embodiment.

Referring to FIG. 7, in operation S710, a game providing device may obtain the quantity of the first cryptocurrency 220 owned by an electronic wallet. For example, in a case in which the first cryptocurrency 220 is set as a cryptocurrency providing the in-game effect, the game providing device may obtain the quantity of the first cryptocurrency 220 owned by the electronic wallet.

In operation S720, the game providing device may obtain the quantity of the first cryptocurrency 220 by converting the quantity of the second cryptocurrency 230 owned by the electronic wallet into the quantity of the first cryptocurrency 220, based on an exchange rate between the first cryptocurrency 220 and the second cryptocurrency 230. For example, the second cryptocurrency 230 may be set as a cryptocurrency that provides the in-game effect together with the first cryptocurrency 220, but the second cryptocurrency 230 and the first cryptocurrency 220 may differ from each other in effect provided per unit of cryptocurrency, due to the difference in value therebetween. In this case, the game providing device may obtain the quantity of a first cryptocurrency by converting the quantity of the second cryptocurrency 230 owned by the electronic wallet into the quantity of the first cryptocurrency 220, based on the exchange rate between the first cryptocurrency 220 and the second cryptocurrency 230.

In an embodiment, the game providing device may store the quantity of the first cryptocurrency 220. In an embodiment, the game providing device may display the quantity of the first cryptocurrency 220, as the information 240 about the cryptocurrency in the game.

In operation S730, the game providing device may provide the in-game effect 250 in proportion to the quantity of the cryptocurrency. Operation S730 may correspond to operation S720 of FIG. 6, and thus redundant descriptions will be omitted.

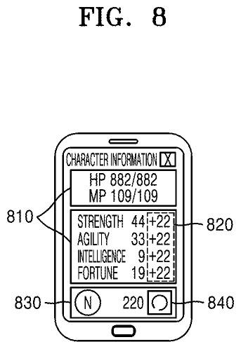

FIG. 8 is a diagram for describing an interface for displaying an in-game effect according to various embodiments.

FIG. 8 illustrates an example of a character information interface 800 displayed on a user terminal. FIG. 8 illustrates an example of an interface for displaying the in-game effect in a case in which the in-game effect of improving the ability of a character of a user is provided based on information of a cryptocurrency, and the form of the interface for displaying the in-game effect is not limited to the example.

According to various embodiments, the character information interface 800 may include a character ability information interface 810, a cryptocurrency effect interface 820, a cryptocurrency information interface 830, and a refresh interface 840. The character information interface 800 is not limited to the example of FIG. 8, and the character information interface 800 may include more or fewer components than those illustrated shown in FIG. 8. For example, the cryptocurrency information interface 830 may be included in a user interface other than the character information interface 800, or may displayed as an independent user interface. For example, the refresh interface 840 may be omitted.

According to various embodiments, the character ability information interface 810 may be an interface for displaying the ability of the character of the user. The character ability information interface 810 may include the cryptocurrency effect interface 820 for displaying the in-game effect provided based on information of a cryptocurrency owned by an electronic wallet linked to an account of the user.

In an embodiment, the cryptocurrency effect interface 820 may display all in-game effects provided based on information of a cryptocurrency. For example, the cryptocurrency effect interface 820 may display the ability of the character that is improved based on the information of the cryptocurrency. In an embodiment, the cryptocurrency effect interface 820 may display the in-game effect provided per unit of the cryptocurrency. For example, the cryptocurrency effect interface 820 may display an increase in the ability of the character provided per unit of the cryptocurrency.

In an embodiment, the cryptocurrency effect interface 820 may provide a function of displaying more detailed information about the in-game effect provided based on the information of the cryptocurrency. For example, the cryptocurrency effect interface 820 may display, through an icon or an indicator, that the ability of the character is improved based on the information of the cryptocurrency. Based on a user input of clicking or hovering over the icon or indicator, a separate interface for displaying the ability of the character improved based on the information of the cryptocurrency may be displayed.

According to various embodiments, the cryptocurrency information interface 830 may display the information of the cryptocurrency owned by the electronic wallet linked to the account of the user. In an embodiment, the cryptocurrency information interface 830 may display the type and quantity of the cryptocurrency owned by the electronic wallet.

In an embodiment, the cryptocurrency information interface 830 may display only information of a cryptocurrency of a certain type among cryptocurrencies owned by the electronic wallet. For example, in a case in which only a certain type of cryptocurrency provides the in-game effect, the cryptocurrency information interface 830 may display only information of the cryptocurrency that provides the in-game effect.

In an embodiment, the cryptocurrency information interface 830 may display information obtained by converting the cryptocurrency owned by the electronic wallet into a certain type of cryptocurrency. For example, in a case in which a second cryptocurrency provides the in-game effect as much as a quantity obtained by converting the second cryptocurrency into a first cryptocurrency, the cryptocurrency information interface 830 may display information obtained by converting the second cryptocurrency owned by the electronic wallet into the first cryptocurrency.

According to various embodiments, the refresh interface 840 may be an interface for providing a function of updating the cryptocurrency effect interface 820 and the cryptocurrency information interface 830. In an embodiment, in response to obtaining a user input through the refresh interface 840, the game providing device may obtain information of the cryptocurrency owned by the electronic wallet, from the blockchain network based on information of the electronic wallet linked to the account of the user, and update the cryptocurrency effect interface 820 and the cryptocurrency information interface 830 based on the obtained information of the cryptocurrency.

In an embodiment, the game providing device may periodically or conditionally obtain the information of the cryptocurrency to update the in-game effect, without providing the refresh interface 840.

FIG. 9 is a diagram for describing a detailed configuration of a game providing device according to various embodiments.

As illustrated in FIG. 9, the game providing device 900 according to some embodiments may include at least one processor 910, a communication unit 930, and a memory 950. However, not all of the components illustrated in FIG. 9 are essential components of the game providing device 900. The game providing device 900 may be implemented by more or fewer components than the components illustrated in FIG. 9. The game providing device 900 may be a user terminal, a server, a game network system, or a separate device.

According to an embodiment, the processor 910 generally controls the overall operation of the game providing device 900. For example, the processor 910 may execute a program stored in the memory 950 to control the overall operation of the communication unit 930 and the memory 950. The processor 910 may control the operation of the game providing device 900 in the specification by controlling the communication unit 930 and the memory 950.

According to an embodiment, the processor 910 may be configured to link an electronic wallet for trading a cryptocurrency over a blockchain network, to an account of a user using a game service, obtain information of a cryptocurrency owned by the electronic wallet, and provide a certain in-game effect to the user, based on the obtained information of the cryptocurrency.

According to an embodiment, the processor 910 may be configured to obtain electronic wallet information including at least one of identification information of the electronic wallet and authentication information of the electronic wallet, verify the validity of the obtained electronic wallet information, and based on the obtained electronic wallet information being valid, register the obtained electronic wallet information in the account of the user.

According to an embodiment, the processor 910 may be configured to obtain the quantity of the cryptocurrency owned by the electronic wallet.

According to an embodiment, the processor 910 may be configured to obtain the quantity of a cryptocurrency of a certain type owned by the electronic wallet.

According to an embodiment, the processor 910 may be configured to obtain a quantity of a second cryptocurrency by converting the quantity of the first cryptocurrency owned by the electronic wallet into the second cryptocurrency based on the exchange rate between the first cryptocurrency and the second cryptocurrency.

According to an embodiment, the processor 910 may be configured to provide the in-game effect in proportion to the quantity of the cryptocurrency.

According to an embodiment, the processor 910 may be configured to, based on the quantity of the cryptocurrency being greater than a preset threshold value, provide the in-game effect with a maximum value regardless of the quantity of the cryptocurrency.

According to an embodiment, the processor 910 may be further configured to provide an interface for displaying, in a game screen, the obtained information of the cryptocurrency and the provided in-game effect.

According to an embodiment, the communication unit 930 may perform communication with an external device under control by the processor 910. For example, the communication unit 930 may perform communication with an external device, such as a payment server or an authentication server, under control by the processor 910. Also, the communication unit 930 may obtain user information or a user input through communication with an external interface.

The memory 950 may store a program for the processor 910 to perform processing and control, and may store data input to or output from the game providing device 900. According to an embodiment, the memory 950 may store information about a user account.

According to an embodiment, the memory 950 may store information of an electronic wallet linked to the account of the user. In an embodiment, the information of the electronic wallet may include at least one of identification information of the electronic wallet and authentication information of the electronic wallet.

According to an embodiment, the memory 950 may store information of a cryptocurrency owned by the electronic wallet. According to an embodiment, the memory 950 may store information about an in-game effect provided to the user.

According to an embodiment, the processor 910 may execute a method of providing a game service, by using a program stored in the memory 950.

According to an embodiment, the memory 950 may include at least one of a flash memory-type storage medium, a hard disk-type storage medium, a multimedia card micro-type storage medium, a card-type memory (e.g., SD or XD memory), random-access memory (RAM), static RAM (SRAM), read-only memory (ROM), electrically erasable programmable ROM (EEPROM), programmable ROM (PROM), magnetic memory, a magnetic disk, and an optical disc. In addition, according to an embodiment, programs stored in the memory 950 may be classified into a plurality of modules according to their functions.

According to an embodiment, the method of providing a game service may be performed by the game providing device 900, or may be performed by a server or a user terminal, and at least one component included in the game providing device 900 may perform the embodiments described above with reference to FIGS. 1 to 8.

In addition, the method of providing a game service may be performed by a server and a user terminal individually or together. Configurations of the server and the user terminal will be described in detail below with reference to FIGS. 10 and 11.

FIG. 10 is a diagram for describing a detailed configuration of a server according to various embodiments.

As illustrated in FIG. 10, the server 1000 according to some embodiments may include at least one processor 1010, a communication unit 1030, and a memory 1050. However, not all of the components illustrated in FIG. 10 are essential components of the server 1000. The server 1000 may be implemented by more or fewer components than the components illustrated in FIG. 10.

According to an embodiment, the processor 1010 generally controls the overall operation of the server 1000. For example, the processor 1010 may execute a program stored in the memory 1050 to control the overall operation of the communication unit 1030 and the memory 1050. The processor 1010 may control the operation of the server 1000 in the specification by controlling the communication unit 1030 and the memory 1050.

According to an embodiment, the processor 1010 may be configured to link an electronic wallet for trading a cryptocurrency over a blockchain network, to an account of a user using a game service, obtain information of a cryptocurrency owned by the electronic wallet, and provide a certain in-game effect to the user, based on the obtained information of the cryptocurrency.

According to an embodiment, the operation of the processor 1010 may correspond to the operation of the processor 910 of the game providing device 900 described above with reference to FIG. 9, and thus a detailed description thereof will be omitted.

The communication unit 1030 may provide a query to the user terminal 1100 and receive response information to the query, under control by the processor 1010. In addition, according to an embodiment, the communication unit 1030 may transmit and receive data to and from the user terminal 1100, and the data transmitted and received to and from the user terminal 1100 may include control data for controlling the user terminal 1100 or a program included in the user terminal 1100.

The memory 1050 may store a program for the processor 1010 to perform processing and control, and may store data input to or output from the server 1000. According to an embodiment, the memory 1050 may store information about a user account.

According to an embodiment, the memory 1050 may store information of an electronic wallet linked to an account of a user. In an embodiment, the information of the electronic wallet may include at least one of identification information of the electronic wallet and authentication information of the electronic wallet.

According to an embodiment, the memory 1050 may store information of a cryptocurrency owned by the electronic wallet. According to an embodiment, the memory 1050 may store information about an in-game effect provided to the user.

According to an embodiment, the processor 1010 may execute a method of providing a game service, by using a program stored in the memory 1050.

According to an embodiment, the memory 1050 may include at least one of a flash memory-type storage medium, a hard disk-type storage medium, a multimedia card micro-type storage medium, a card-type memory (e.g., SD or XD memory), RAM, SRAM, ROM, EEPROM, PROM, magnetic memory, a magnetic disk, and an optical disc. In addition, according to an embodiment, programs stored in the memory 1050 may be classified into a plurality of modules according to their functions.

In addition, according to an embodiment, the method of providing a game service may be performed by the server 1000 and the user terminal 1100 in a distributed manner, may be individually performed by the server 1000 and the user terminal 1100, or may be performed by the game providing device 900.

FIG. 11 is a diagram for describing a detailed configuration of a user terminal according to various embodiments.

As illustrated in FIG. 11, the user terminal 1100 according to some embodiments may include at least one processor 1110, a communication unit 1130, a memory 1150, and a user interface 1170. However, not all of the components illustrated in FIG. 11 are essential components of the user terminal 1100. The user terminal 1100 may be implemented by more or fewer components than the components illustrated in FIG. 11.

According to an embodiment, the processor 1110 generally controls the overall operation of the user terminal 1100. For example, the processor 1110 may execute a program stored in the memory 1150 to control the overall operation of the communication unit 1130, the memory 1150, and the user interface 1170. The processor 1110 may control the operation of the user terminal 1100 in the specification by controlling the communication unit 1130, the memory 1150, and the user interface 1170.

According to an embodiment, the processor 1110 may be configured to link an electronic wallet for trading a cryptocurrency over a blockchain network, to an account of a user using a game service, obtain information of a cryptocurrency owned by the electronic wallet, and provide a certain in-game effect to the user, based on the obtained information of the cryptocurrency.

According to an embodiment, the operation of the processor 1110 may correspond to the operation of the processor 910 of the game providing device 900 described above with reference to FIG. 9, and thus a detailed description thereof will be omitted.

The communication unit 1130 may provide a query to the server 1000 and receive response information to the query, under control by the processor 1110. In addition, according to an embodiment, the communication unit 1130 may transmit and receive data to and from the server 1000, and the data transmitted and received to and from the server 1000 may include control data for controlling the user terminal 1100 or a program included in the user terminal 1100.

According to an embodiment, the communication unit 1130 may include a Bluetooth communication unit, a BLE communication unit, an NFC unit, a wireless local area network (WLAN) (e.g., Wi-Fi) communication unit, a Zigbee communication unit, an Infrared Data Association (IrDA) communication unit, a Wi-Fi Direct (WFD) communication unit, an ultra-wideband (UWB) communication unit, an Ant+ communication unit, etc., but is not limited thereto.

In addition, according to an embodiment, the communication unit 1130 transmits and receives radio signals to and from at least one of a base station, an external terminal, and a server, over a mobile communication network. Here, the wireless signal may include a voice call signal, a video call signal, or various types of data according to text/multimedia message transmission and reception.

The memory 1150 may store a program for the processor 1110 to perform processing and control, and may store data input to or output from the user terminal 1100. According to an embodiment, the memory 1150 may store information about a user account.

According to an embodiment, the processor 1110 may execute a method of providing a game service, by using a program stored in the memory 1150.

According to an embodiment, the memory 1150 may include at least one of a flash memory-type storage medium, a hard disk-type storage medium, a multimedia card micro-type storage medium, a card-type memory (e.g., SD or XD memory), RAM, SRAM, ROM, EEPROM, PROM, magnetic memory, a magnetic disk, and an optical disc. In addition, according to an embodiment, programs stored in the memory 1150 may be classified into a plurality of modules according to their functions.

According to an embodiment, the user interface 1170 may include various interfaces. For example, the user interface 1170 may include various interfaces, such as a key pad, a dome switch, a voice input interface, a fingerprint input interface, a touch input interface (e.g., a touch-type capacitive touch pad, a pressure-type resistive overlay touch pad, an infrared sensor-type touch pad, a surface acoustic wave conduction touch pad, an integration-type tension measurement touch pad, a piezoelectric effect-type touch pad, etc.), a camera, a jog wheel, or a jog switch, and may link various sensors, such as an acceleration sensor, a position sensor, a temperature sensor, or an optical sensor, to a user interface. The disclosure is not limited to the above examples.

In addition, according to an embodiment, the user interface 1170 may further include an output unit (not shown). The output unit may include at least one of a liquid-crystal display, a thin-film-transistor liquid-crystal display, an organic light-emitting diode, a flexible display, a three-dimensional (3D) display, and an electrophoretic display. In a case in which a display and a touch pad constitute a layer structure to form a touch screen, the display may serve as an input device in addition to an output device. In addition, the output unit (not shown) may include a light-emitting diode (LED) lamp, a vibration motor, a speaker, a flash, and the like, but is not limited to the above examples.

In addition, according to an embodiment, the user interface 1170 may output a notification of game information in the form of an image, a video, a sound, a vibration, a lamp, or the like.

The device described above may be implemented as a hardware component, a software component, and/or a combination of a hardware component and a software component. For example, devices and components described in the embodiments may be implemented by using one or more general-purpose computers or special-purpose computers, such as a processor, a controller, an arithmetic logic unit (ALU), a digital signal processor, a microcomputer, a field-programmable gate array (FPGA), a programmable logic unit (PLU), a microprocessor, or any other device configured to execute and respond to instructions. The processor may execute an operating system (OS) and one or more software applications running on the operating system. The processor may also access, store, modify, process, and generate data in response to execution of software. Although some embodiments are described, for convenience of understanding, with reference to examples in which a single processor is used, one of skill in the art would understand that a processor may include a plurality of processing elements and/or a plurality of types of processing elements. For example, the processor may include one or more processors and one controller. In addition, other processing configurations are also possible, such as a parallel processor.

The software may include a computer program, code, instructions, or a combination of one or more thereof, and may configure the processor to operate as desired or may independently or collectively instruct the processor. Software and/or data may be embodied permanently or temporarily in any type of machine, component, physical or virtual equipment, computer storage medium or device, or in a propagated signal wave capable of providing instructions or data to or being interpreted by the processor. Software may be distributed on networked computer systems and stored or executed in a distributed manner. The software and data may be stored in one or more computer-readable recording media.

The method according to an embodiment may be embodied as program commands executable by various computer devices, and recorded on a computer-readable medium. The computer-readable medium may include program instructions, data files, data structures, or the like separately or in combinations. The program commands to be recorded on the medium may be specially designed and configured for an embodiment, or may be well-known to and be usable by those skill in the art of computer software. Examples of the computer-readable recording medium include magnetic media such as hard disks, floppy disks, or magnetic tapes, optical media such as compact disc ROMs (CD-ROMs) or digital video discs (DVDs), magneto-optical media such as floptical disks, and hardware devices such as ROM, RAM, and flash memory, which are specially configured to store and execute program instructions. Examples of the program instructions include not only machine code, such as code made by a compiler, but also high-level language code that is executable by a computer by using an interpreter or the like. The hardware device may be configured to operate as one or more software modules to perform an operation of an embodiment, and vice versa.

Although the embodiments have been described with the limited embodiments and the drawings, various modifications and changes may be made by those of skill in the art from the above description. For example, the described techniques may be performed in a different order from the described method, and/or components of the described system, structure, device, circuit, etc. may be combined or integrated in a different form from the described method, or may be replaced or substituted by other components or equivalents to achieve appropriate results.

Therefore, other implementations or embodiments, and equivalents of the following claims are within the scope of the claims.

Devices and methods according to various embodiments provide an in-game effect based on information of a cryptocurrency owned by a user using a game service, thereby providing a method capable of elevating interest in a game.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of providing a game service, the method comprising:
linking an electronic wallet for trading a cryptocurrency over a blockchain network, to an account of a user using the game service;
obtaining information of a cryptocurrency owned by the electronic wallet; and
based on the obtained information of the cryptocurrency, providing a certain in-game effect to the user.

2. The method of claim 1, wherein the linking of the electronic wallet comprises:
obtaining electronic wallet information comprising at least one of identification information of the electronic wallet and authentication information of the electronic wallet;
verifying validity of the obtained electronic wallet information; and
based on the obtained electronic wallet information being valid, registering the obtained electronic wallet information in the account of the user.

3. The method of claim 1, wherein the obtaining of the information of the cryptocurrency comprises obtaining a quantity of the cryptocurrency owned by the electronic wallet.

4. The method of claim 3, wherein the obtaining of the information of the cryptocurrency further comprises obtaining a quantity of a cryptocurrency of a certain type owned by the electronic wallet.

5. The method of claim 3, wherein the obtaining of the quantity of the cryptocurrency comprises obtaining a quantity of a first cryptocurrency by converting a quantity of a second cryptocurrency owned by the electronic wallet into the quantity of the first cryptocurrency, based on an exchange rate between the first cryptocurrency and the second cryptocurrency.

6. The method of claim 3, wherein the in-game effect is provided in proportion to the quantity of the cryptocurrency.

7. The method of claim 3, wherein, based on the quantity of the cryptocurrency being greater than a preset threshold value, the in-game effect is provided in a fixed amount regardless of the quantity of the cryptocurrency.

8. The method of claim 1, wherein the providing of the in-game effect comprises, based on the obtained information of the cryptocurrency, improving an ability of a character of the user in a game.

9. The method of claim 1, further comprising providing an interface for displaying, in a game screen, the obtained information of the cryptocurrency and the provided in-game effect.

10. The method of claim 1, wherein the electronic wallet is for trading a cryptocurrency different from a virtual currency used in the game service.

11. A device for providing a game, the device comprising:
a memory storing instructions; and
at least one processor functionally coupled to the memory,
wherein the at least one processor is configured to execute the instructions to link an electronic wallet for trading a cryptocurrency over a blockchain network, to an account of a user using a game service, obtain information of a cryptocurrency owned by the electronic wallet, and based on the obtained information of the cryptocurrency, provide a certain in-game effect to the user.

12. The device of claim 11, wherein the at least one processor is further configured to execute the instructions to obtain electronic wallet information comprising at least one of identification information of the electronic wallet and authentication information of the electronic wallet, verify validity of the obtained electronic wallet information, and based on the obtained electronic wallet information being valid, register the obtained electronic wallet information in the account of the user.

13. The device of claim 11, wherein the at least one processor is further configured to execute the instructions to obtain a quantity of the cryptocurrency owned by the electronic wallet.

14. The device of claim 13, wherein the at least one processor is further configured to execute the instructions to obtain a quantity of a cryptocurrency of a certain type owned by the electronic wallet.

15. The device of claim 13, wherein the at least one processor is further configured to execute the instructions to obtain a quantity of a first cryptocurrency by converting a quantity of a second cryptocurrency owned by the electronic wallet into the quantity of the first cryptocurrency, based on an exchange rate between the first cryptocurrency and the second cryptocurrency.

16. The device of claim 13, wherein the at least one processor is further configured to execute the instructions to provide the in-game effect in proportion to the quantity of the cryptocurrency.

17. The device of claim 13, wherein the at least one processor is further configured to execute the instructions to, based on the quantity of the cryptocurrency being greater than a preset threshold value, provide the in-game effect in a fixed amount regardless of the quantity of the cryptocurrency.

18. The device of claim 11, wherein the at least one processor is further configured to execute the instructions to, based on the obtained information of the cryptocurrency, improve an ability of the user in the game.

19. The device of claim 11, wherein the at least one processor is further configured to execute the instructions to provide an interface for displaying, in a game screen, the obtained information of the cryptocurrency and the provided in-game effect.

20. The device of claim 11, wherein the electronic wallet is for trading a cryptocurrency different from a virtual currency used in the game service.

21. A server comprising:
a memory storing instructions; and
at least one processor functionally coupled to the memory,
wherein the at least one processor is configured to execute the instructions to link an electronic wallet for trading a cryptocurrency over a blockchain network, to an account of a user using a game service, obtain information of a cryptocurrency owned by the electronic wallet, and based on the obtained information of the cryptocurrency, provide a certain in-game effect to the user.

22. A computer program recorded on a medium for executing a method of providing a game service in combination with hardware, the method comprising:
linking an electronic wallet for trading a cryptocurrency over a blockchain network, to an account of a user using the game service;
obtaining information of a cryptocurrency owned by the electronic wallet; and
based on the obtained information of the cryptocurrency, providing a certain in-game effect to the user.

23. A computer-readable recording medium having recorded thereon a program for executing, on a computer, a method of providing a game service, the method comprising:
linking an electronic wallet for trading a cryptocurrency over a blockchain network, to an account of a user using the game service;
obtaining information of a cryptocurrency owned by the electronic wallet; and
based on the obtained information of the cryptocurrency, providing a certain in-game effect to the user.
